(19) United States
(12) Patent Application Publication
(10) Pub. No.: US 2009/0136162 A1
(43) Pub. Date: May 28, 2009

(54) Gift Bag For Maintaining an Emotional Connection or Conveying a Show of Support

(76) Inventor: Douglas D. Lazarus, Watertown, MA (US)

Correspondence Address: FOX ROTHSCHILD LLP;PRINCETON PIKE CORPORATE CENTER, 2000 Market Street, Tenth Floor, Philadelphia, PA, 19103, US

(21) Appl. No.: 12/271,409

(22) Filed: Nov. 14, 2008

Related U.S. Application Data
(60) Provisional application No. 60/988,081, filed on Nov. 14, 2007.

(51) Int. Cl. B65D 33/28; G09B 19/08

(52) U.S. Cl. 383/72; 283/45

(57) ABSTRACT

A drawstring bag to be given as a gift containing message strips inside having a product functional life of at least one year, so that the amount of message strips is at least enough for at least one message strip to be removed every day. According to one embodiment, the message strips contain messages suitable for presentation to a child, spouse or parent. According to another embodiment, the drawstring bag is decorated for presentation on special events such as birthdays, anniversaries, St. Valentine's Day, Father's Day, Mother's Day, Christmas or an illness. According to another embodiment, the message strips contain messages of encouragement for when a child is at school or living away from the family, or when the recipient is in the armed services, hospital or prison.

### CROSS-REFERENCE TO RELATED APPLICATION

The present invention claims priority benefit under 35 U.S.C. §119(e) of U.S. Provisional Patent Application Ser. No. 60/988,081 filed Nov. 14, 2007, the disclosure of which is incorporated herein by reference.

### BACKGROUND OF THE INVENTION

This invention relates generally to a means of maintaining an emotional connection or a show of support between the person that gives the gift and the person that receives the gift. By using this product as it is designed to be used—every day—the connection or support is received daily for as long as a year.

Many products are commercially available for emotional or supportive purposes. This includes books, greeting cards, and other types of printed products as well as gift items that have a printed message as part of them, such as dolls, pictures or plaques for the home or workplace. One example is the Friendship Blessing Jar, a product sold over the internet. This product is a jar filled with 31 blessings—one for every day of the month. However, it is not designed to be carried on the person, it is sold with a shorter period of use implied, up to a month-long life-span, and it offers blessings rather than a direct message that denotes love or support.

Other products are useful over a longer period of time, e.g., an individualized coffee mug or calendar or a self-help book. However, there is an unmet need for a product that provides a daily message that denotes love or support.

### SUMMARY OF THE INVENTION

The present invention addresses these need. According to one embodiment of the present invention, a drawstring bag to be given as a gift is provided, containing message strips inside having a product functional life of at least one year, so that the amount of message strips is at least enough for at least one message strip to be removed every day.

According to one embodiment the message strips each contain a different message. According to another embodiment, the message strips all relate to a common theme. One example of a common theme relates to love or affection for the gift recipient. Another example of a common theme is a humorous theme. In yet another example, the message strips contain messages suitable for presentation to a child, spouse or parent. According to another example, the message strips contain messages of encouragement for when a child is at school, when a child is living away from the family, or when the recipient is in the armed services, hospital or prison

According to another embodiment, the bag is constructed of a material that renders it suitable for subsequent re-use. In one example, the drawstring bag is decorated for presentation on a special event such as birthdays, anniversaries, St. Valentine's Day, Father's Day, Mother's Day, Christmas or an illness.

According to another embodiment, the drawstring bag has a product functional life of less than one year, and is packaged in combination with instructions for one message strip to be removed every day.

### BRIEF DESCRIPTION OF THE DRAWING

FIG. 1 is a side view of a gift bag according to one embodiment of the present invention.

### DETAILED DESCRIPTION OF THE PREFERRED EMBODIMENT

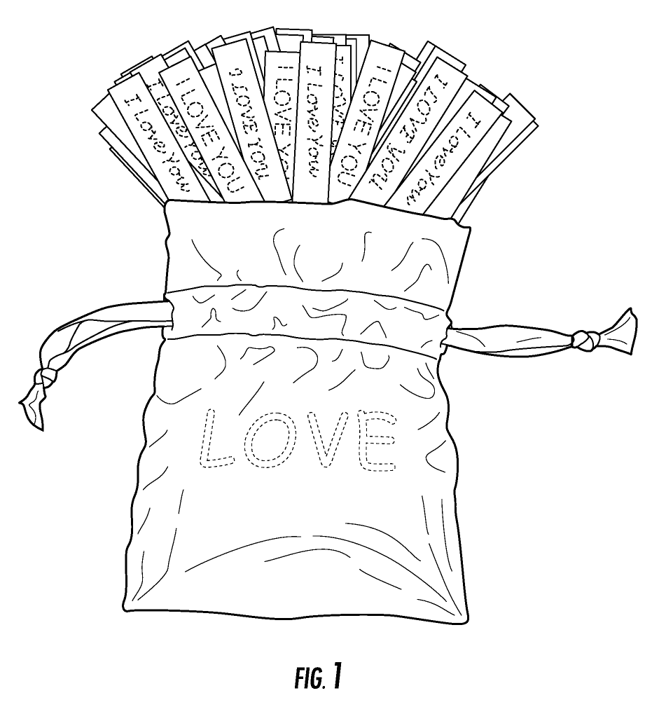

A gift bag according to one embodiment of the present invention is depicted in FIG. 1. Drawstring bag 3 contains message strips 2 with printed messages 1 expressing affection for the recipient of the bag. The bag 3 is closed by drawstring 4 and is decorated with a message 5 suitable for presentation on a special event.

To use the gift bag, the recipient removes at least one, and preferably only one, message strip every day. Although the gift bag preferably contains 365 message strips, this action is independent of the number of message strips contained in the product when it is used. Indeed, product variations with fewer than 365 message strips are equally valid as a way that the gift-giver can present this product design to maintain a connection with the recipient.

According to one embodiment, the message theme the gift bag of the present invention is designed to convey is “I love you.” This product of this embodiment is designed so that upon removing a message strip from the drawstring bag, the recipient will be reminded that the gift-giver loves him or her. However, variations that include other messages are also equally valid as a way that the gift-giver can maintain a connection with the recipient.

The present invention provides such a novelty-type message delivery of love and support which is adapted to be carried with the person, e.g., in a purse or car, so that it can be used daily without extra effort on the part of the recipient. The invention contains two main parts—1) the drawstring bag and 2) the message strips. The drawstring bag by itself can be used for additional purposes, e.g., to carry change, and still provide the same message of love and support from the gift-giver.

The present invention is constructed and adapted to be available in gift shops and other retail outlets and through mail and parcel carriers to those who may be vacationing in a particular region and/or wish to convey not only a written message or parcel to someone but also wishes to utilize the mode of conveyance as a novelty means of sharing the experience of being in a remote region during travel or vacation or simply utilizing a unique form of expression.

The description of the preferred embodiments should be taken as illustrating, instead of limiting, the present invention as defined by the claims. As will be readily appreciated, numerous combinations of all features set forth above can be used without departing from the invention set forth in the claims. Such variations are not regarded as a departure from the spirit and scope of the invention and all such modifications are intended to be included within the scope of the following claims.

What is claimed is:

1. A drawstring bag to be given as a gift containing message strips inside having a product functional life of at least one year, so that the amount of message strips is at least enough for at least one message strip to be removed every day.

2. The drawstring bag of claim 1, wherein said message strips each contain a different message.

3. The drawstring bag of claim 2, wherein said message strips all relate to a common theme.

4. The drawstring bag of claim 3, wherein said common theme relates to love or affection for the gift recipient.

5. The drawstring bag of claim 3, wherein said common theme is a humorous theme.

6. The drawstring bag of claim 1, wherein said bag is constructed of a material that renders it suitable for subsequent re-use.

7. The drawstring bag of claim 1, wherein said message strips comprise messages suitable for presentation to a child, spouse or parent

8. The drawstring bag of claim 1, wherein said drawstring bag is decorated for presentation on a special event.

9. The drawstring bag of claim 8, wherein said special event is selected from birth-days, anniversaries, St. Valentine's Day, Father's Day, Mother's Day, Christmas or an illness.

10. The drawstring bag of claim 1, wherein said message strips comprise messages of encouragement for when a child is at school, when a child is living away from the family, or when the recipient is in the armed services, hospital or prison

11. A drawstring bag to be given as a gift containing message strips inside that would have a product functional life of less than one year, and packaged in combination with instructions for one message strip to be removed every day.

12. The drawstring bag of claim 11, wherein said message strips each contain a different message.

13. The drawstring bag of claim 12, wherein said message strips all relate to a common theme.

14. The drawstring bag of claim 13, wherein said common theme relates to love or affection for the gift recipient.

15. The drawstring bag of claim 13, wherein said common theme is a humorous theme.

16. The drawstring bag of claim 11, wherein said bag is constructed of a material that renders it suitable for subsequent re-use.

17. The drawstring bag of claim 11, wherein said message strips comprise messages suitable for presentation to a child, spouse or parent

18. The drawstring bag of claim 11, wherein said drawstring bag is decorated for presentation on a special event.

19. The drawstring bag of claim 18, wherein said special event is selected from birth-days, anniversaries, St. Valentine's Day, Father's Day, Mother's Day, Christmas or an illness.

20. The drawstring bag of claim 11, wherein said message strips comprise messages of encouragement for when a child is at school, when a child is living away from the family, or when the recipient is in the armed services, hospital or prison.
